(19) United States
(12) Patent Application Publication
(10) Pub. No.: US 2017/0053058 A1
(43) Pub. Date: Feb. 23, 2017

(54) MODEL-BASED RULE TABLE GENERATION

(71) Applicant: Taiwan Semiconductor Manufacturing Company, Ltd., Hsin-Chu (TW)

(72) Inventors: Jue-Chin Yu, Taichung City (TW); Shuo-Yen Chou, Haulien County (TW)

(21) Appl. No.: 14/832,884

(22) Filed: Aug. 21, 2015

(51) Int. Cl. G06F 17/50

(52) U.S. Cl. CPC G06F 17/5081; G06F 17/5022; G06F 2217/06

(57) ABSTRACT

Provided is a method for fabricating a semiconductor device including receiving an integrated circuit (IC) layout pattern, for example, from a design house. In some embodiments, a process simulation model is utilized to generate a freeform layout pattern by an inverse lithography technology (ILT) process. The process simulation model is configured to simulate processing conditions for the IC layout pattern. In various embodiments, the freeform layout pattern is associated with the IC layout pattern. In some examples, a simplified layout pattern is generated, where the simplified layout pattern is an approximation of the freeform layout pattern. Thereafter, sub-resolution assist feature (SRAF) rules, based on the simplified layout pattern, may be calculated and an SRAF rule table may be generated.

### BACKGROUND

The electronics industry has experienced an ever increasing demand for smaller and faster electronic devices which are simultaneously able to support a greater number of increasingly complex and sophisticated functions. Accordingly, there is a continuing trend in the semiconductor industry to manufacture low-cost, high-performance, and low-power integrated circuits (ICs). Thus far these goals have been achieved in large part by scaling down semiconductor IC dimensions (e.g., minimum feature size) and thereby improving production efficiency and lowering associated costs. However, such scaling has also introduced increased complexity to the semiconductor manufacturing process. Thus, the realization of continued advances in semiconductor ICs and devices calls for similar advances in semiconductor manufacturing processes and technology.

As merely one example, scaling down of IC dimensions has been achieved by extending the usable resolution of a given lithography generation by the use of one or more resolution enhancement technologies (RETs), such as phase shift masks (PSMs), off-axis illumination (OAI), and optical proximity correction (OPC). RETs may be used to modify mask layouts to compensate for processing limitations used in the manufacture of an IC and which manifest themselves as process technology nodes are scaled down. Without RETs, simple scaling down of layout designs used at larger nodes often results in inaccurate or poorly shaped features. For example, rounded corners on a device feature that is designed to have right-angle corners may become more pronounced and/or may become critically distorted at smaller technology nodes, preventing a device with such a distorted feature from performing as desired. Other examples of inaccurate or poorly shaped pattern features may include pinching, necking, bridging, dishing, erosion, metal line thickness variations, and/or other such characteristics that can directly affect device performance. One type of OPC technique includes inserting sub-resolution assist features (SRAFs) into a design layout to prevent inaccurate or poorly shaped features. However, SRAF insertions largely rely on an empirically generated rule table. In a conventional example, a large number of heuristically designed patterns may be lithographically processed (e.g., exposed and developed), after which the patterns are empirically measured and a rule table is generated and/or updated. Such pattern design, processing, and empirical data collection is a labor-intensive and time-consuming process which adds undesirable delays to a technology development cycle. Thus, existing techniques have not proved entirely satisfactory in all respects.

### BRIEF DESCRIPTION OF THE DRAWINGS

Aspects of the present disclosure are best understood from the following detailed description when they are read with the accompanying figures. It is noted that, in accordance with the standard practice in the industry, various features are not drawn to scale. In fact, the dimensions of the various features may be arbitrarily increased or reduced for clarity of discussion.

FIG. 1 is a simplified block diagram of an embodiment of an integrated circuit (IC) manufacturing system and an associated IC manufacturing flow;

FIG. 2 illustrates flow diagrams for methods of generating assist feature rule tables for IC mask patterns according to prior art methods;

FIG. 3 is a more detailed block diagram of the mask house shown in FIG. 1 according to various aspects of the present disclosure;

FIG. 4 shows a high-level flowchart of a method 400 of generating assist feature rule tables for IC mask patterns according to various aspects of the present disclosure;

FIG. 5A illustrates an IC pattern of an IC design layout, according to some embodiments of the method 400;

FIG. 5B illustrates a freeform layout pattern associated with the IC pattern, according to some embodiments of the method 400;

FIG. 5C illustrates a simplified pattern which is an approximation of the freeform layout pattern, according to some embodiments of the method 400;

FIG. 5D illustrates a model-based rule table (MBRT) which is determined in part by the simplified pattern of FIG. 5C, in accordance with some embodiments of the method 400;

FIGS. 6A-6C, 7A-7C, 8A-8C, and 9A-9C illustrates various embodiments of simplified patterns that may be used to approximate the freeform layout pattern, according to some embodiments of the method 400;

FIGS. 10A and 10B illustrate embodiments of the method 400, as applied to an alternative IC design layout;

FIGS. 11A-11D illustrate an exemplary method of SRAF rule table generation for at least some types of layout patterns, in accordance with some embodiments; and

FIGS. 12A-12D illustrate an exemplary method of SRAF rule table generation for at least some alternative types of layout patterns, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The present disclosure is generally related to a model-based rule table generation method that effectively overcomes the shortcomings of empirically generated rule table-based SRAF insertions. Specifically, embodiments of the present disclosure provide for the generation of a process-aware rule table for SRAF insertions. As used herein, the term “process-aware rule table” is used to define a rule table that is generated, at least in part, by a process simulation for a given layout feature(s). In contrast to conventional methods which require lithographic processing and empirical data collection, embodiments disclosed herein provide for the automated generation of a rule table for SRAF insertions based on a simulated process for adaptive, rapid rule table creation without costly development cycle delays.

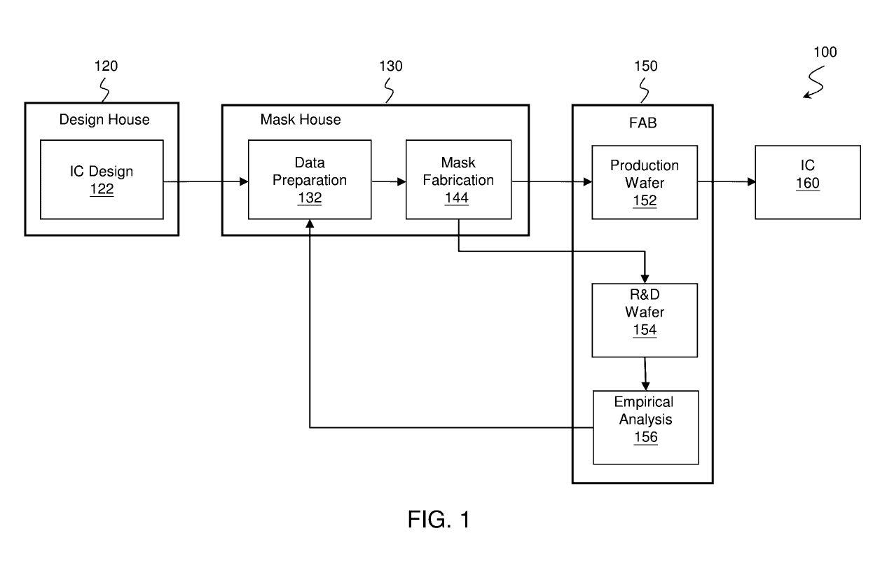

FIG. 1 is a simplified block diagram of an embodiment of an integrated circuit (IC) manufacturing system 100 and an IC manufacturing flow associated therewith, which may benefit from various aspects of the present disclosure. The IC manufacturing system 100 includes a plurality of entities, such as a design house 120, a mask house 130, and an IC manufacturer 150 (i.e., a fab), that interact with one another in the design, development, and manufacturing cycles and/or services related to manufacturing an integrated circuit (IC) device 160. The plurality of entities are connected by a communications network, which may be a single network or a variety of different networks, such as an intranet and the Internet, and may include wired and/or wireless communication channels. Each entity may interact with other entities and may provide services to and/or receive services from the other entities. One or more of the design house 120, mask house 130, and IC manufacturer 150 may have a common owner, and may even coexist in a common facility and use common resources.

In various embodiments, the design house 120, which may include one or more design teams, generates an IC design layout 122. The IC design layout 122 may include various geometrical patterns designed for the fabrication of the IC device 160. By way of example, the geometrical patterns may correspond to patterns of metal, oxide, or semiconductor layers that make up the various components of the IC device 160 to be fabricated. The various layers combine to form various features of the IC device 160. For example, various portions of the IC design layout 122 may include features such as an active region, a gate electrode, source and drain regions, metal lines or vias of a metal interconnect, openings for bond pads, as well as other features known in the art which are to be formed within a semiconductor substrate (e.g., such as a silicon wafer) and various material layers disposed on the semiconductor substrate. In various examples, the design house 120 implements a design procedure to form the IC design layout 122. The design procedure may include logic design, physical design, and/or place and route. The IC design layout 122 may be presented in one or more data files having information related to the geometrical patterns which are to be used for fabrication of the IC device 160. In some examples, the IC design layout 122 may be expressed in a GDSII file format or DFII file format.

In some embodiments, the design house 120 may transmit the IC design layout 122 to the mask house 130, for example, via the network connection described above. The mask house 130 may then use the IC design layout 122 to manufacture one or more masks to be used for fabrication of the various layers of the IC device 160 according to the IC design layout 122. In various examples, the mask house 130 performs mask data preparation 132, where the IC design layout 122 is translated into a form that can be physically written by a mask writer, and mask fabrication 144, where the design layout prepared by the mask data preparation 132 is modified to comply with a particular mask writer and/or mask manufacturer and is then fabricated. In the example of FIG. 1, the mask data preparation 132 and mask fabrication 144 are illustrated as separate elements; however, in some embodiments, the mask data preparation 132 and mask fabrication 144 may be collectively referred to as mask data preparation.

In some examples, the mask data preparation 132 includes application of one or more resolution enhancement technologies (RETs) to compensate for potential lithography errors, such as those that can arise from diffraction, interference, or other process effects. In some examples, optical proximity correction (OPC) may be used to adjust line widths depending on the density of surrounding geometries, add “dog-bone” end-caps to the end of lines to prevent line end shortening, correct for electron beam (e-beam) proximity effects, or for other purposes as known in the art. For example, OPC techniques may add sub-resolution assist features (SRAFs), which for example may include adding scattering bars, serifs, and/or hammerheads to the IC design layout 122 according to optical models or rules such that, after a lithography process, a final pattern on a wafer is improved with enhanced resolution and precision. The mask data preparation 132 may also include further RETs, such as off-axis illumination (OAI), phase-shifting masks (PSM), other suitable techniques, or combinations thereof. One technique that may be used in conjunction with OPC is inverse lithography technology (ILT), which treats OPC as an inverse imaging problem and computes a mask pattern using an entire area of a design pattern rather than just edges of the design pattern. While ILT may in some cases produce unintuitive mask patterns, ILT may be used to fabricate masks having high fidelity and/or substantially improved depth-of-focus and exposure latitude, thereby enabling printing of features (i.e., geometric patterns) that may otherwise have been unattainable. In some embodiments, an ILT process may be more generally referred to as a model-based (MB) mask correction process. To be sure, in some examples, other RET techniques such as those described above and which may use a model, for example, to calculate SRAF shapes, etc. may also fall within the scope of a MB mask correction process.

The mask data preparation 132 may further include a mask rule checker (MRC) that checks the IC design layout that has undergone one or more RET processes (e.g., OPC, ILT, etc.) with a set of mask creation rules which may contain certain geometric and connectivity restrictions to ensure sufficient margins, to account for variability in semiconductor manufacturing processes, etc. In some cases, the MRC modifies the IC design layout to compensate for limitations which may be encountered during mask fabrication 144, which may modify part of the modifications performed by the one or more RET processes in order to meet mask creation rules. For example, the MRC may perform Manhattan conversion to convert an ILT-processed mask design which is very curvy and/or contoured (i.e., manufacturing-unfriendly) into a more simplified, regular polygon pattern (i.e., manufacturing-friendly), for example to accommodate an e-beam mask writer, as discussed below.

In some embodiments, the mask data preparation 132 may further include lithography process checking (LPC) that simulates processing that will be implemented by the IC manufacturer 150 to fabricate the IC device 160. The LPC may simulate this processing based on the IC design layout 122 to create a simulated manufactured device, such as the IC device 160. The processing parameters in LPC simulation may include parameters associated with various processes of the IC manufacturing cycle, parameters associated with tools used for manufacturing the IC, and/or other aspects of the manufacturing process. By way of example, LPC may take into account various factors, such as aerial image contrast, depth of focus (“DOF”), mask error enhancement factor (“MEEF”), other suitable factors, or combinations thereof. As described in more detail below, the simulated processing (e.g., implemented by the LPC) can be used to provide for the generation of a process-aware rule table (e.g., for SRAF insertions). Thus, in various embodiments, an SRAF rule table may be generated for the specific IC design layout 122, with consideration of the processing conditions of the IC manufacturer 150.

In some embodiments, after a simulated manufactured device has been created by LPC, if the simulated device layout is not close enough in shape to satisfy design rules, certain steps in the mask data preparation 132, such as OPC and MRC, may be repeated to refine the IC design layout 122 further. In such cases, the previously generated SRAF rule table may also be updated.

It should be understood that the above description of the mask data preparation 132 has been simplified for the purposes of clarity, and data preparation may include additional features such as a logic operation (LOP) to modify the IC design layout according to manufacturing rules. Additionally, the processes applied to the IC design layout 122 during data preparation 132 may be executed in a variety of different orders.

After mask data preparation 132 and during mask fabrication 144, a mask or a group of masks may be fabricated based on the modified IC design layout. For example, an electron-beam (e-beam) or a mechanism of multiple e-beams is used to form a pattern on a mask (photomask or reticle) based on the modified IC design layout. The mask can be formed in various technologies. In an embodiment, the mask is formed using binary technology. In some embodiments, a mask pattern includes opaque regions and transparent regions. A radiation beam, such as an ultraviolet (UV) beam, used to expose a radiation-sensitive material layer (e.g., photoresist) coated on a wafer, is blocked by the opaque region and transmitted through the transparent regions. In one example, a binary mask includes a transparent substrate (e.g., fused quartz) and an opaque material (e.g., chromium) coated in the opaque regions of the mask. In some examples, the mask is formed using a phase shift technology. In a phase shift mask (PSM), various features in the pattern formed on the mask are configured to have a pre-configured phase difference to enhance image resolution and imaging quality. In various examples, the phase shift mask can be an attenuated PSM or alternating PSM.

In some embodiments, the IC manufacturer 150, such as a semiconductor foundry, uses the mask (or masks) fabricated by the mask house 130 to transfer one or more mask patterns onto a production wafer 152 and thus fabricate the IC device 160 on the production wafer 152. The IC manufacturer 150 may include an IC fabrication facility that may include a myriad of manufacturing facilities for the fabrication of a variety of different IC products. For example, the IC manufacturer 150 may include a first manufacturing facility for front end fabrication of a plurality of IC products (i.e., front-end-of-line (FEOL) fabrication), while a second manufacturing facility may provide back end fabrication for the interconnection and packaging of the IC products (i.e., back-end-of-line (BEOL) fabrication), and a third manufacturing facility may provide other services for the foundry business. In various embodiments, the semiconductor wafer (i.e., the production wafer 152) within and/or upon which the IC device 160 is fabricated may include a silicon substrate or other substrate having material layers formed thereon. Other substrate materials may include another suitable elementary semiconductor, such as diamond or germanium; a suitable compound semiconductor, such as silicon carbide, indium arsenide, or indium phosphide; or a suitable alloy semiconductor, such as silicon germanium carbide, gallium arsenic phosphide, or gallium indium phosphide. In some embodiments, the semiconductor wafer may further include various doped regions, dielectric features, and multilevel interconnects (formed at subsequent manufacturing steps). Moreover, the mask (or masks) may be used in a variety of processes. For example, the mask (or masks) may be used in an ion implantation process to form various doped regions in the semiconductor wafer, in an etching process to form various etching regions in the semiconductor wafer, and/or in other suitable processes.

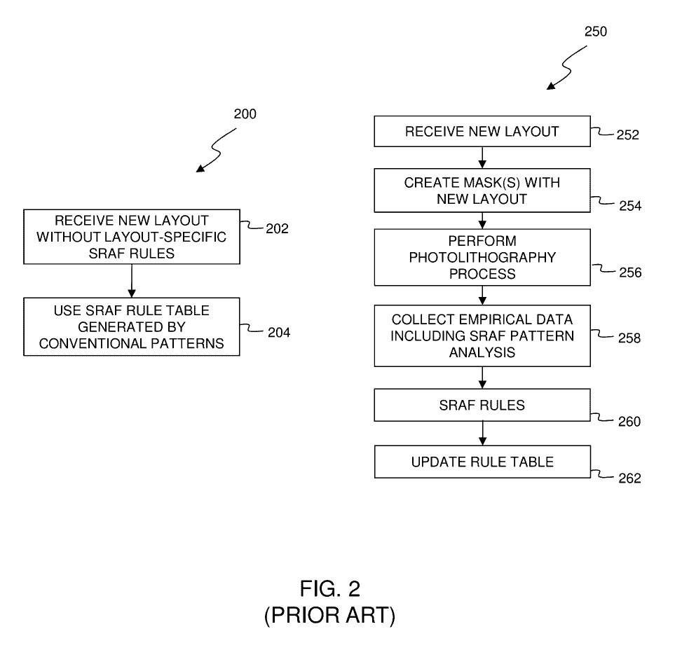

In contrast to the embodiments disclosed herein, conventional techniques may not use the simulated processing (e.g., provided by the LPC) to provide the generation of a process-aware rule table (e.g., for SRAF insertions). By way of example, and with reference to FIGS. 1 and 2, in a conventional method 200, the IC design layout 122 received (e.g., from the mask house 130) may include a new layout for which layout-specific SRAF rules do not exist (block 202). In some cases, the mask data preparation 132 may thus simply use an SRAF rule table generated by conventional patterns (block 204). In such examples, non-conventional patterns (e.g., single-pattern layout features) may not be accounted for by the conventional SRAF rule table (e.g., during the mask fabrication 144), which may lead to pattern distortion and/or failure or degradation of the IC device 160. Method 250 of FIG. 2 illustrates an alternative method in accordance with some conventional embodiments. As shown in the method 250, a new layout may be received at block 252. One or more features of the new layout may be patterned onto one or more masks (e.g., by the mask fabrication 144) for empirical testing of the new layout at block 254. By way of example, the IC manufacturer 150 may use the mask (or masks) fabricated by the mask house 130 (having the one or more features of the new layout) to transfer one or more mask patterns onto a research and development (R&D) wafer 154 (FIG. 1) and thus perform one or more photolithography processes (block 256) on the R&D wafer 154. In various embodiments, the photolithography processes include patterning of experimental SRAF patterns onto the R&D wafer 154. After photolithography processing of the R&D wafer 154, the R&D wafer 154 may then be transferred to a test lab (e.g., metrology lab or parametric test lab) for empirical analysis 156. Thus, empirical data from the R&D wafer 154 may be collected at block 258, including evaluation of the experimental SRAF patterns. In various examples, the empirical SRAF pattern data may then be transferred to the mask house 130, where SRAF rules for the received new layout may be determined (block 260), for example, based on the empirical SRAF data. Thereafter, the SRAF rule table (which may have previously only included SRAF rules determined by conventional patterns) may be updated at block 262 to include the SRAF rules for the new layout as determined at block 260. The mask house 130 may thereby generate a robust SRAF rule table and thereafter use the robust SRAF rule table for the mask fabrication 144.

While conventional techniques may provide for a robust SRAF rule table, as described above, the cost for providing such an empirically generated SRAF rule table is quite high. In various conventional examples, the mask house 130 may have to provide a large number of heuristically designed patterns, which are then lithographically processed (e.g., exposed and developed) by the IC manufacturer 150, after which the patterns are empirically measured (e.g., by the empirical analysis 156) and a rule table is generated and/or updated (e.g., by the mask house 130). Thus, the pattern design, processing, and empirical data collection is a labor-intensive and time-consuming process which adds undesirable delays to a technology development cycle, and it is certainly not a process that can be repeated every time a new layout design and/or new single layout feature is encountered. Alternatively, as described in more detail below, embodiments of the present disclosure provide for the automated generation of an SRAF rule table which provides for SRAF insertions based on a simulated process (e.g., as simulated by the LPC) for adaptive, rapid rule table creation without having to process R&D wafers and collect empirical SRAF data, which is costly and results in technology development cycle delays.

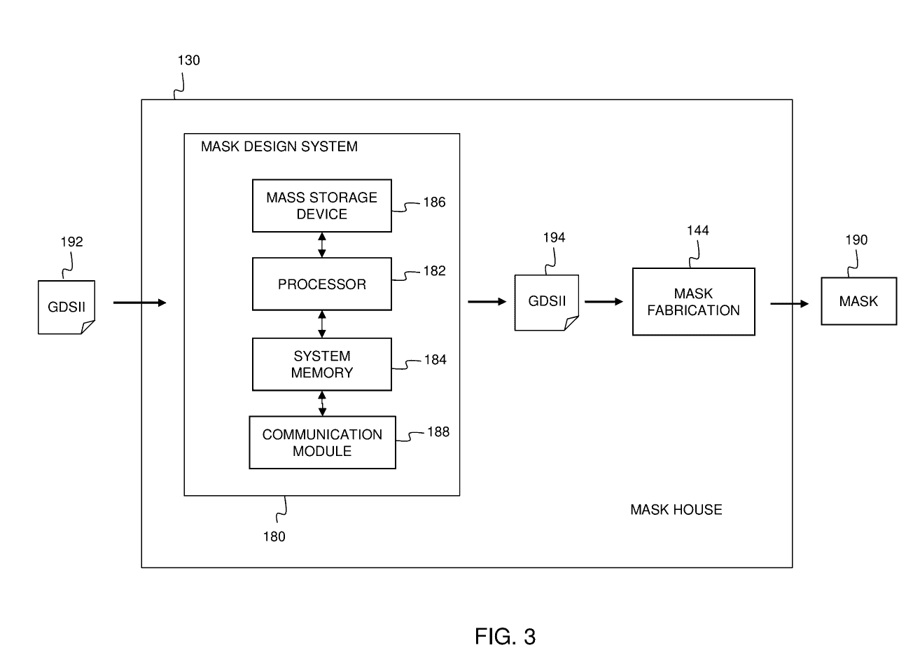

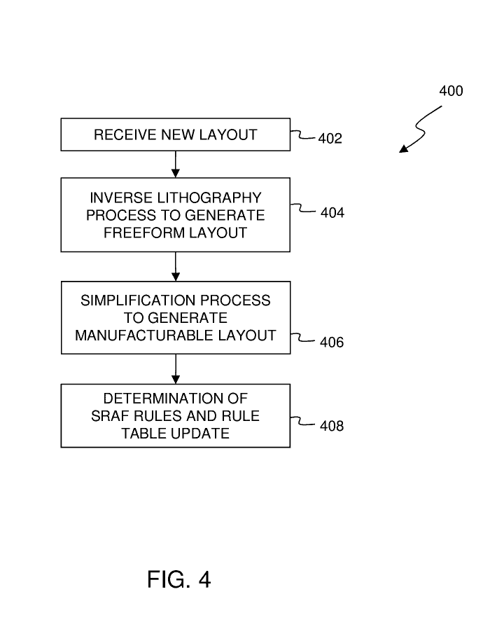

Referring now to FIG. 3, provided therein is a more detailed block diagram of the mask house 130 shown in FIG. 1 according to various aspects of the present disclosure. In the example of FIG. 3, the mask house 130 includes a mask design system 180 that is operable to perform the functionality described in association with mask data preparation 132 of FIG. 1 and in association with method 400 of FIG. 4, discussed below. The mask design system 180 is an information handling system such as a computer, server, workstation, or other suitable device. The system 180 includes a processor 182 that is communicatively coupled to a system memory 184, a mass storage device 186, and a communication module 188. The system memory 184 provides the processor 182 with non-transitory, computer-readable storage to facilitate execution of computer instructions by the processor. Examples of system memory may include random access memory (RAM) devices such as dynamic RAM (DRAM), synchronous DRAM (SDRAM), solid state memory devices, and/or a variety of other memory devices known in the art. Computer programs, instructions, and data are stored within the mass storage device 186. Examples of mass storage devices may include hard discs, optical disks, magneto-optical discs, solid-state storage devices, and/or a variety other mass storage devices known in the art. The communication module 188 is operable to communicate information such as IC design layout files with the other components in the IC manufacturing system 100, such as design house 120. Examples of communication modules may include Ethernet cards, 802.11 WiFi devices, cellular data radios, and/or other suitable devices known in the art.

In operation, the mask design system 180 is configured to manipulate the IC design layout 122 according to a variety of design rules and limitations before it is transferred to a mask 190 by mask fabrication 144. For example, in an embodiment, mask data preparation 132, including ILT, OPC, MRC, and LPC, may be implemented as software instructions executing on the mask design system 180. In such an embodiment, the mask design system 180 receives a first GDSII file 192 containing the IC design layout 122 from the design house 120. After the mask data preparation 132 is complete, which may be after completion of the method 400 of FIG. 4, the mask design system 180 transmits a second GDSII file 194 containing a modified IC design layout to mask fabrication 144 (i.e., to a mask fabricator). In alternative embodiments, the IC design layout may be transmitted between the components in IC manufacturing system 100 in alternate file formats such as DFII, CIF, OASIS, or any other suitable file type. Further, the mask design system 180 and the mask house 130 may include additional and/or different components in alternative embodiments.

FIG. 4 shows a flow chart of a method 400 for modifying an IC design layout before mask fabrication according to various embodiments. In some embodiments, the method 400 may be implemented in the mask data preparation 132 of mask house 130 shown in FIG. 1. Although the present embodiment describes the method 400 as creating a mask pattern from an IC pattern, it can also be viewed as creating another mask pattern from an existing mask pattern by transforming or modifying the existing mask pattern. Furthermore, the method 400 can also be used in a maskless fabrication process, where an IC design layout is converted to, through a process including the method 400, a format accessible by a maskless fabrication tool, such as an e-beam direct writer. Additional operations can be provided before, during, and after the method 400, and some operations described can be replaced, eliminated, or moved around for additional embodiments of the method. It is also noted that the method 400 is exemplary, and is not intended to limit the present disclosure beyond what is explicitly recited in the claims that follow. The method 400 will be further described below in conjunction with FIGS. 1, 3, 5A-5D, 6A-6C, 7A-7C, 8A-8C, 9A-9C, and 10A/10B.

The method 400 begins at block 402 where the mask house 130 receives the IC design layout 122. The IC design layout 122 includes various geometrical patterns representing features of an integrated circuit (IC). For example, the IC design layout 122 may include main IC features such as an active region, a gate electrode, source and drain regions, metal lines or vias of a metal interconnect, openings for bond pads that may be formed in a semiconductor substrate (such as a silicon wafer) and various material layers disposed over the semiconductor substrate. In some embodiments, the IC design layout 122 may also include certain assist features, such as those features for imaging effect, processing enhancement, and/or mask identification information.

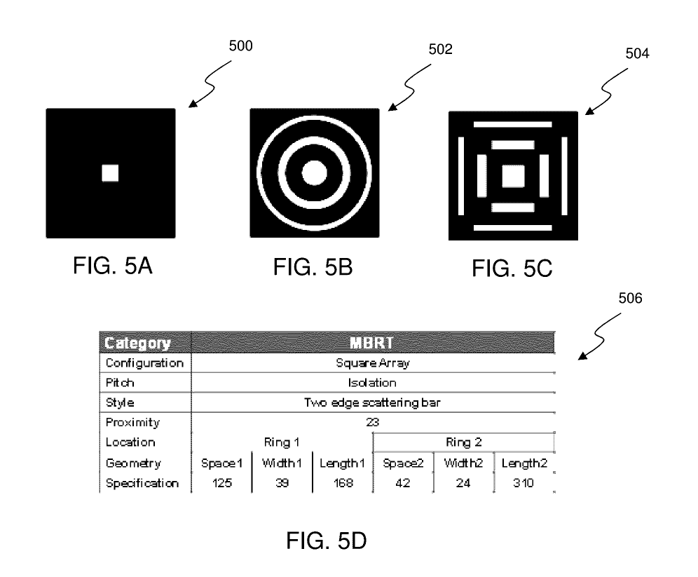

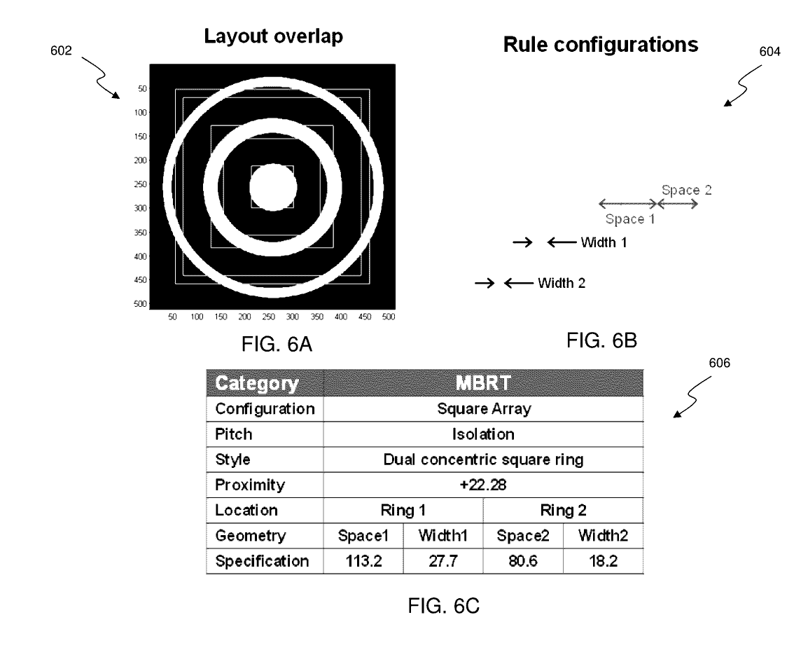

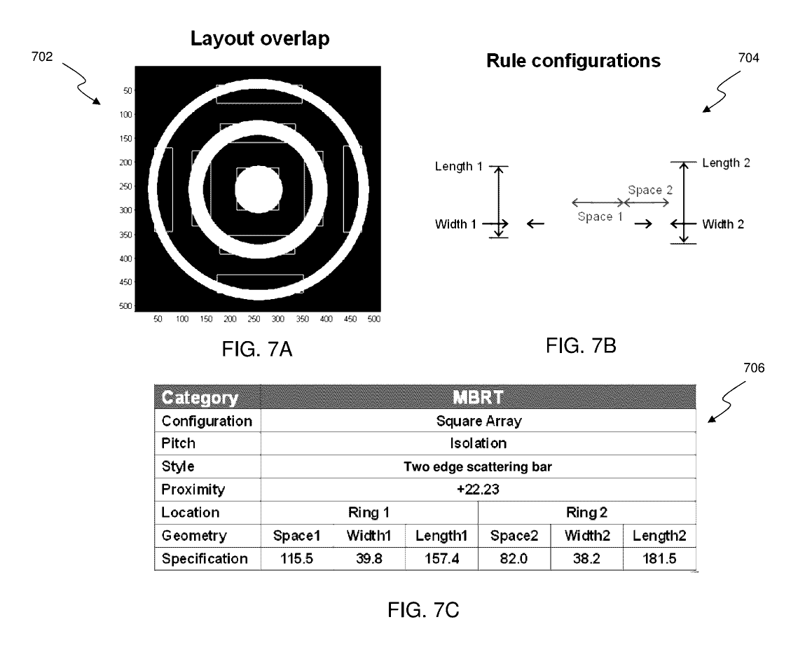

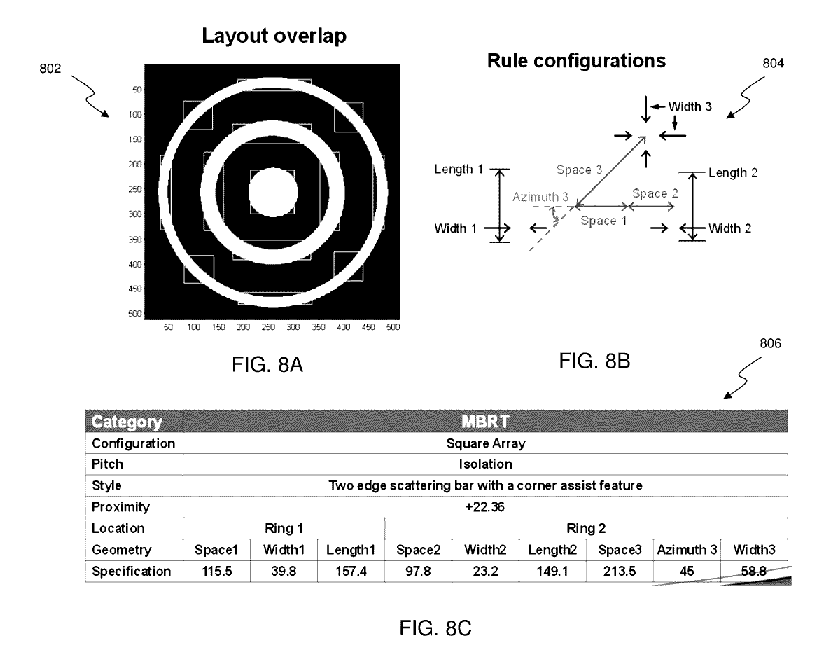

With reference to the example of FIG. 5A, in an embodiment of block 402, illustrated therein is an example IC pattern 500 which may be a pattern contained in the received IC design layout 122. In the example of FIG. 5A, the IC pattern 500 includes a square, which in some examples may represent a via or contact feature. The method 400 proceeds to block 404, where a model-based (MB) mask correction process is performed (e.g., by the mask data preparation 132). In at least some examples, the MB mask correction process includes an inverse lithography technology (ILT) process. In particular, a theoretical model is provided (e.g., by the mask data preparation 132) that simulates processing that will be implemented by the IC manufacturer 150 to fabricate the IC pattern 500. The term “theoretical model”, as used and described herein, may be equivalently referred to as a “process simulation model”. By way of example, the theoretical/process simulation model may include a model presented by a sum of coherent systems (SOCS). In various examples, the imaging formulation performed by the theoretical/process simulation model may utilize one or more models/formulations as known in art, such as Köhler's illumination model, Abbe's Method, and Hopkin's Method, among others. In some cases, the theoretical/process simulation model may include modeling of a partially coherent imaging system, a coherent imaging system, or an incoherent imaging system.

In various embodiments, the process simulation provided by the theoretical model is used during the ILT process to generate a freeform layout pattern 502, as shown in FIG. 5B, where the freeform layout pattern 502 is associated with the IC pattern 500 of FIG. 5A. In some examples, the freeform layout pattern corresponds to a layout hotspot. In some cases, the freeform layout pattern corresponds to a layout without an original SRAF table. In some embodiments, the ILT process considers a plurality of manufacturing constraints (e.g., of the IC manufacturer's process) such as pattern fidelity at various exposure/defocus values, process window size, and/or mask complexity. In various examples, one or more different manufacturing constraints may be emphasized over another, thereby allowing the ILT process to generate various freeform layout patterns in accordance with various process and/or device needs.

In various embodiments, the freeform layout pattern 502, generated by the ILT process, may be an ideal layout design for the IC pattern 500, given the manufacturing constraints of the IC manufacturer's process and given the process simulation for fabrication of the IC pattern 500. However, the freeform layout pattern 502 is not manufacturing-friendly, and thus presents difficulties for subsequent processing, such as mask fabrication 144. Therefore, conversion of the freeform layout pattern 502 to one or more fabrication-friendly shapes (or geometrical patterns) is in order. As used herein, “manufacturing unfriendly” patterns may be used to describe patterns that are not manufacturable given the processes and/or processing/lithography equipment used by the IC manufacturer 150, and/or patterns which are manufacturable but take too much time for mask creation (i.e., for mask writing).

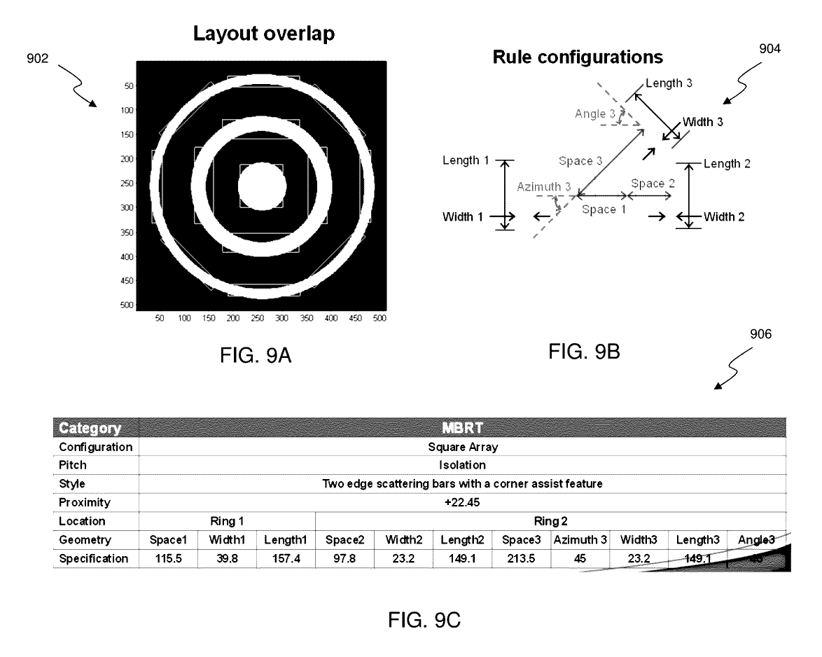

The method 400 proceeds to block 406 where a simplification process to generate a “manufacturing friendly” (i.e., a manufacturable mask layout which may be written in an acceptable amount of time) is performed (e.g., by the mask data preparation 132). In particular, a goal of the simplification process is to derive one or more manufacturing-friendly shapes approximating the freeform layout pattern 502. In an embodiment, one of a plurality of user-defined fabrication-friendly shapes, such as a square or rectangle, is chosen, and then a position and size of the shape are subsequently determined in order to replace the freeform layout pattern 502 in the IC design layout 122, or alternatively to be used in another design layout transformed from the IC design layout 122. In some embodiments, a simplified pattern 504 (FIG. 5C) approximating the freeform layout pattern 502 (FIG. 5B) is derived by the simplification process (at block 406). As shown in the example of FIG. 5C, the simplified pattern 504 includes a square surrounded by a plurality of rectangular edge scattering bars. However, in other examples, the simplification process may generate other types of simplified patterns, as discussed below with reference to FIGS. 6A-6C, 7A-7C, 8A-8C, 9A-9C, and 10A/10B.

The method 400 proceeds to block 408 where SRAF rules are determined (e.g., by the mask data preparation 132) and the SRAF rule table is updated. In particular, SRAF rules for the IC pattern 500 may be extracted and/or calculated based on the theoretical model and the simplified pattern 504. As shown in FIG. 5D, a model-based rule table (MBRT) 506 is determined based on the theoretical model and the simplified pattern 504. As shown in the example of FIG. 5D, the MBRT 506 may include various information such as a configuration name, a pitch, a style, a proximity, and specifications of the geometry (e.g., space, width, and length) for each of the scattering bars for the two simplified rings (“Ring 1” and “Ring 2”) surrounding the center square. In various embodiments, determination of the MBRT 506 may include creation of a new rule table or updating a previously existing rule table. In some embodiments, the SRAF rule table may include a rule-based rule table, wherein the rules are determined by conventional patterns. Additionally, in some embodiments, the SRAF rule table includes a model-based rule table (e.g., the MBRT 506). In some cases, the SRAF rule table may include a hybrid rule table composed of both a rule-based table and a model-based rule table. The MBRT 506, once determined, may be applied to any similar layout patterns (e.g., including similar layout hotspots). By way of example, “similar layout patterns” or “similar layout hotspots” may refer to patterns/hotspots that have a substantially similar geometric shape (e.g., within a pre-defined/user-defined tolerance), as known in the art. In some embodiments, the method 400 may be applied again for each critical layout pattern, for any single-pattern layout features, and/or for any other layout pattern or feature requiring SRAF feature insertion. As used herein, the term “critical layout pattern” or “critical feature” refers to areas in a layout that are more prone to defects during photolithography processing. In some examples, such error-prone layout areas may be referred to as layout “hotspots”. While different layout designs (e.g., corresponding to different circuits or devices and/or from a variety of different design houses or customers) may include different types of layout hotspots, the embodiments disclosed herein are not limited to a particular type of hotspot, but rather can be applied to any layout pattern and/or feature as needed or desired. Thus, in some embodiments, the method 400 may further provide for the identification of layout hotspots, followed by the automated generation (e.g., by the mask data preparation 132) of a rule table for SRAF insertions based on a simulated process of fabrication of a received IC pattern for adaptive, rapid rule table creation without costly development cycle delays encountered by conventional SRAF rule table generation.

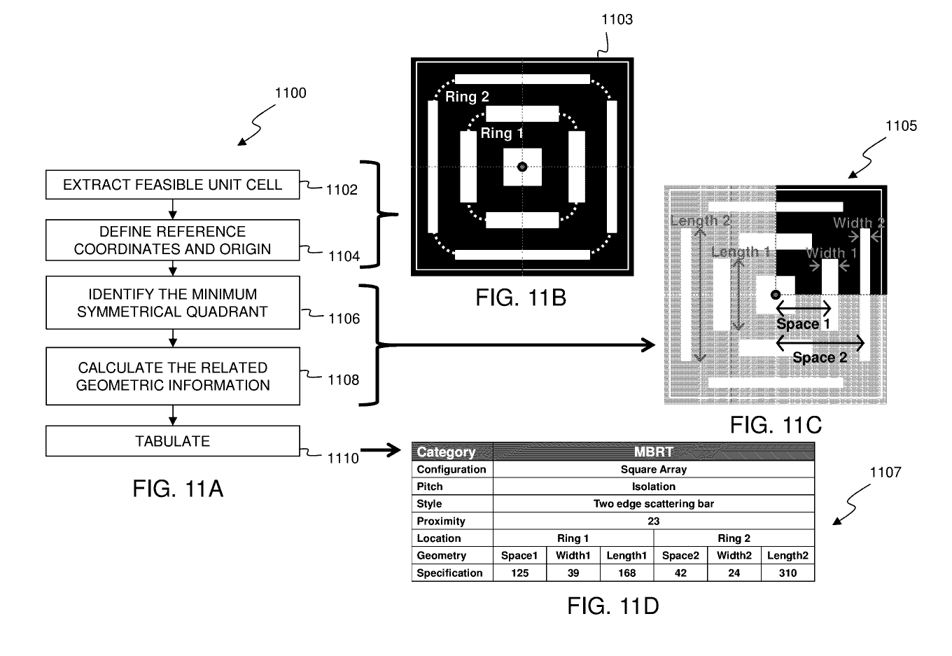

By way of example, and in various embodiments, SRAF rule table generation may include a plurality of steps (e.g., performed by the mask data preparation 132). FIGS. 11A-11D illustrate an exemplary method of SRAF rule table generation for embodiments which include a regular/array unit pattern (e.g., similar to the examples shown in FIGS. 5B/5C, 7A/7B, 8A/8B, 9A/9B). With reference to FIG. 11A, illustrated therein is a method 1100 for SRAF rule table generation, in accordance with some embodiments. The method 1100 begins at block 1102 where a feasible unit cell is extracted (e.g., unit cell 1103 shown in FIG. 11B). The method 1100 proceeds to block 1104 where an origin and reference coordinates are defined (e.g., also illustrated in FIG. 11B). The method 1100 then proceeds to block 1106 where a minimum symmetric quadrant is identified (e.g., such as upper-right quadrant 1105 shown in FIG. 11C). The method 1100 proceeds to block 1108 where related geometric information is calculated (e.g., such as ‘Length 1’, ‘Length 2’, ‘Width 1’, ‘Width 2’, ‘Space 1’, and ‘Space 2’ also shown in FIG. 11C). The method 1100 may then proceed to block 1110 where a rule table (e.g., rule table 1107 shown in FIG. 11D) is tabulated and/or otherwise determined.

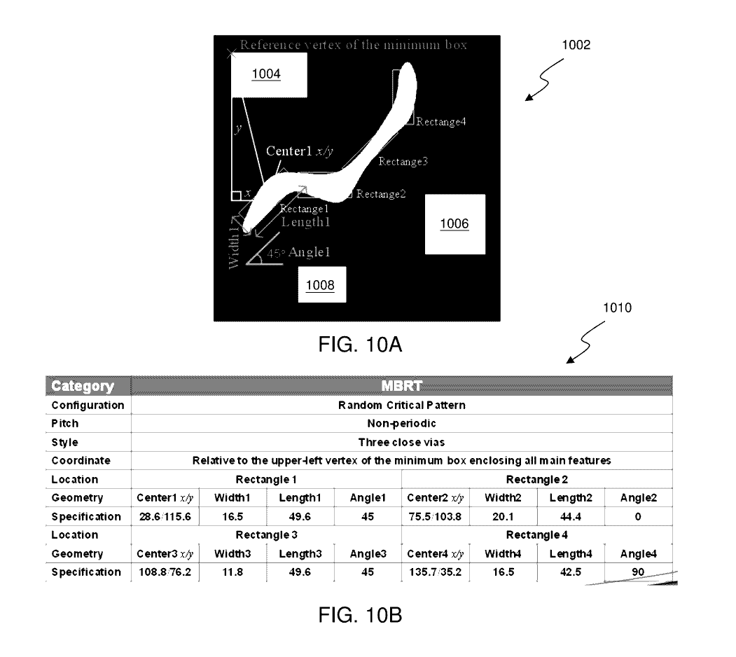

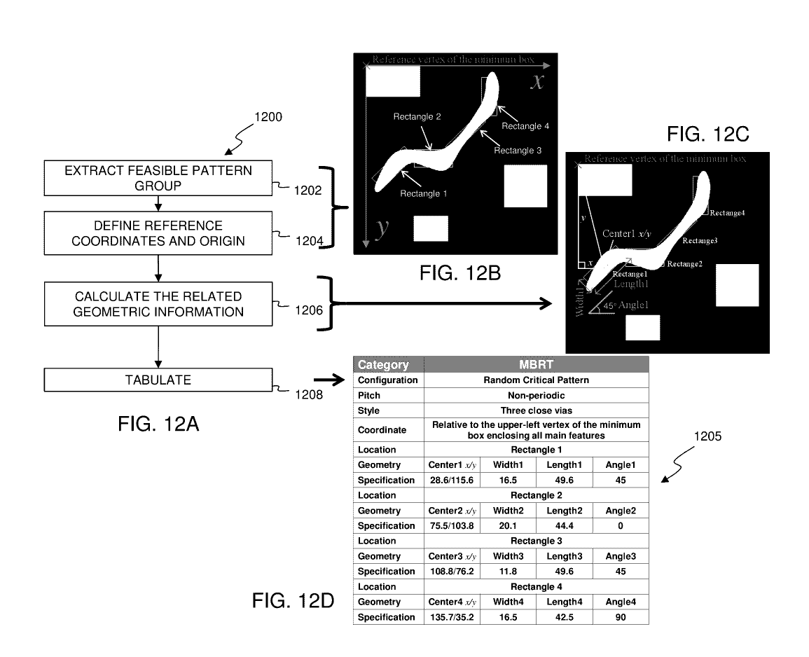

FIGS. 12A-12D illustrate an exemplary method of SRAF rule table generation for embodiments which include an arbitrary pattern (e.g., similar to the example shown in FIG. 10A). With reference to FIG. 12A, illustrated therein is a method 1200 for SRAF rule table generation, in accordance with some embodiments. The method 1200 begins at block 1202 where a feasible pattern group is extracted (e.g., Rectangles 1, 2, 3, 4 shown in FIGS. 12B and 12C). The method 1200 proceeds to block 1204 where an origin/reference vertex and reference coordinates are defined (e.g., also illustrated in FIG. 12B). The method 1200 then proceeds to block 1206 where related geometric information is calculated (e.g., such as ‘Length 1’, ‘Width 1’, ‘Angle 1’, and ‘Center 1’ also shown in FIG. 12C). The method 1200 may then proceed to block 1208 where a rule table (e.g., rule table 1205 shown in FIG. 12D) is tabulated and/or otherwise determined.

The methods 1100 and 1200, similar to the method 400, may also be used in a maskless fabrication process, as described above. Also, additional operations can be provided before, during, and after the methods 1100 and 1200, and some operations described can be replaced, eliminated, or moved around for additional embodiments of the method. It is also noted that the methods 1100 and 1200 are exemplary, and are not intended to limit the present disclosure beyond what is explicitly recited in the claims that follow.

Referring now to FIGS. 6A-6C, 7A-7C, 8A-8C, and 9A-9C, illustrated therein are various embodiments of simplified patterns (i.e., manufacturing-friendly patterns) that may be generated from the freeform layout pattern 502 shown in FIG. 5B. For example, FIG. 6B illustrates a simplified pattern 604 including a dual concentric square ring pattern, FIG. 7B illustrates a simplified pattern 704 including a two edge scattering bar pattern, FIG. 8B illustrates a simplified pattern 804 including a two edge scattering bar pattern with corner assist features, and FIG. 9B illustrates a simplified pattern 904 including a two edge scattering bar pattern with oblique corner assist features. As described above, while the freeform layout pattern 502, generated by the ILT process, may be the ideal layout design for the IC pattern 500, it is not a manufacturing-friendly pattern. Thus, in various embodiments, the simplified patterns 504, 604, 704, 804, 904 may be provided as viable, manufacturing-friendly alternatives to the freeform layout pattern 502. However, in determining which of the simplified patterns to implement in place of the freeform layout pattern 502, various factors may be considered, including the manufacturing constraints of the IC manufacturer's process and the process simulation for fabrication of each of the given simplified patterns 504, 604, 704, 804, 904. In general, a computational capability (e.g., of the mask data preparation 132), a production capability (e.g., of the IC manufacturer 150), as well as design and performance constrains of the IC device 160, may all be simultaneously considered as part of a simplified pattern choice decision-making process. As merely one example, such a decision-making process may include what is acceptable, for example, in terms of photolithography performance and/or mask-making fabrication time, for each of the simplified patterns 504, 604, 704, 804, 904. In the various embodiments described herein, the decision-making process (i.e., the choice of which simplified pattern to use) is automated (e.g., performed automatically by the mask data preparation 132) and is part of the process-aware methodology described herein, where for example the simplified pattern chosen, and the subsequently generated SRAF rule table, are both done so with consideration of the processing conditions of the IC manufacturer 150, among other considerations.

With reference to FIGS. 6A, 7A, 8A, and 9A, illustrated therein are layouts 602, 702, 802, and 902, which show each of the simplified patterns 604, 704, 804, 904 superimposed onto the freeform layout pattern 502. By way of example, FIG. 6A illustrates the simplified pattern 604 superimposed onto the freeform layout pattern 502, FIG. 7A illustrates the simplified pattern 704 superimposed onto the freeform layout pattern 502, FIG. 8A illustrates the simplified pattern 804 superimposed onto the freeform layout pattern 502, and FIG. 9A illustrates the simplified pattern 904 superimposed onto the freeform layout pattern 502. As can be appreciated by inspection of the FIGS. 6A, 7A, 8A, and 9A, each of the simplified patterns 604, 704, 804, 904 approximates the freeform layout pattern 502 with a varying degree of fidelity. In some embodiments, the simplified pattern 904 may best approximate the freeform layout pattern 502; however, due to one or more constraints (e.g., oblique scattering bars may not be manufacturable by the IC manufacturer 150), another of the simplified patterns may be selected. In various examples, the different simplified patterns may be available and/or provided, and an appropriate simplified pattern can then be selected (e.g., dynamically, by the data preparation 132) with consideration of the one or more constraints, as described above.

Referring again to the simplified patterns 604, 704, 804, 904 of FIGS. 6B, 7B, 8B, and 9B, illustrated therein are also rule configurations for each of the geometric shapes used to form the various simplified patterns. For example, as shown in FIG. 6B, the simplified pattern 604 may include a ‘Space 1’ (between a center square and the inner ring) and a ‘Width 1’ for the inner ring (‘Ring 1’) and a ‘Space 2’ (between inner and outer rings) and a ‘Width 2’ for the outer ring (‘Ring 2’). If the simplified pattern 604 is chosen to represent the freeform layout pattern 502, and in an embodiment of block 408 of the method 400, SRAF rules may be determined (e.g., by the mask data preparation 132) and the SRAF rule table is updated. In particular, SRAF rules may be extracted and/or calculated based on the theoretical model and the simplified pattern 604. As shown in FIG. 6C, an MBRT 606 is determined. In various examples, the MBRT 606 may include information such as a configuration name (e.g., square array), a pitch (e.g., isolation), a style (e.g., dual concentric square ring), a proximity, and specifications of the geometry (e.g., space and width) for each of the simplified rings (‘Ring 1’ and ‘Ring 2’) surrounding the center square. In some examples, the MBRT 606 may also provide a specification for the center square.

In the example shown in FIG. 7B, the simplified pattern 704 may include a ‘Space 1’ (between a center square and each adjacent, inner scattering bar—‘Ring 1’), a ‘Width 1’ for each bar of the inner ring of scattering bars (‘Ring 1’), and a ‘Length 1’ for each bar of the inner ring of scattering bars (‘Ring 1’). The simplified pattern 704 may further include a ‘Space 2’ (between an inner scattering bar and an adjacent, outer scattering bar—‘Ring 2’), a ‘Width 2’ for each bar of the outer ring of scattering bars (‘Ring 2’), and a ‘Length 2’ for each bar of the outer ring of scattering bars (‘Ring 2’). If the simplified pattern 704 is chosen to represent the freeform layout pattern 502, and in an embodiment of block 408 of the method 400, SRAF rules may be determined (e.g., by the mask data preparation 132) and the SRAF rule table is updated. In particular, SRAF rules may be extracted and/or calculated based on the theoretical model and the simplified pattern 704. As shown in FIG. 7C, an MBRT 706 is determined. In various examples, the MBRT 706 may include information such as a configuration name (e.g., square array), a pitch (e.g., isolation), a style (e.g., two edge scattering bar), a proximity, and specifications of the geometry (e.g., space, width, and length) for each of the simplified rings (‘Ring 1’ and ‘Ring 2’) surrounding the center square. In some examples, the MBRT 706 may also provide a specification for the center square.

In the example shown in FIG. 8B, the simplified pattern 804 may include a ‘Space 1’ (between a center square and each adjacent, inner scattering bar—‘Ring 1’), a ‘Width 1’ for each bar of the inner ring of scattering bars (‘Ring 1’), and a ‘Length 1’ for each bar of the inner ring of scattering bars (‘Ring 1’). The simplified pattern 804 may further include a ‘Space 2’ (between an inner scattering bar and an adjacent, outer scattering bar—‘Ring 2’), a ‘Width 2’ for each bar of the outer ring of scattering bars (‘Ring 2’), a ‘Length 2’ for each bar of the outer ring of scattering bars (‘Ring 2’), a ‘Space 3’ (between the center square and a corner assist feature), an ‘Azimuth 3’ (defining an angle from the center square to the corner assist feature), and a ‘Width 3’ defining a geometry of the corner assist feature. If the simplified pattern 804 is chosen to represent the freeform layout pattern 502, and in an embodiment of block 408 of the method 400, SRAF rules may be determined (e.g., by the mask data preparation 132) and the SRAF rule table is updated. In particular, SRAF rules may be extracted and/or calculated based on the theoretical model and the simplified pattern 804. As shown in FIG. 8C, an MBRT 806 is determined. In various examples, the MBRT 806 may include information such as a configuration name (e.g., square array), a pitch (e.g., isolation), a style (e.g., two edge scattering bar with a corner assist feature), a proximity, and specifications of the geometry (e.g., space, width, length, azimuth) for each of the simplified rings (‘Ring 1’ and ‘Ring 2’) surrounding the center square and for the corner assist features. In some examples, the MBRT 806 may also provide a specification for the center square.

In the example shown in FIG. 9B, the simplified pattern 904 may include a ‘Space 1’ (between a center square and each adjacent, inner scattering bar—‘Ring 1’), a ‘Width 1’ for each bar of the inner ring of scattering bars (‘Ring 1’), and a ‘Length 1’ for each bar of the inner ring of scattering bars (‘Ring 1’). The simplified pattern 904 may further include a ‘Space 2’ (between an inner scattering bar and an adjacent, outer scattering bar—‘Ring 2’), a ‘Width 2’ for bars of the outer ring of scattering bars (‘Ring 2’) orthogonal to the center square, a ‘Length 2’ for bars of the outer ring of scattering bars (‘Ring 2’) orthogonal to the center square, a ‘Space 3’ (between the center square and a corner assist feature), an ‘Azimuth 3’ (defining an angle from the center square to the corner assist feature), a ‘Width 3’ defining a width of a scattering bar used as the corner assist feature, a ‘Length 3’ defining a length of the scattering bar used as the corner assist feature, and an ‘Angle 3’ defining a rotational position of the oblique scattering bar used as the corner assist feature. If the simplified pattern 904 is chosen to represent the freeform layout pattern 502, and in an embodiment of block 408 of the method 400, SRAF rules may be determined (e.g., by the mask data preparation 132) and the SRAF rule table is updated. In particular, SRAF rules may be extracted and/or calculated based on the theoretical model and the simplified pattern 904. As shown in FIG. 9C, an MBRT 906 is determined. In various examples, the MBRT 906 may include information such as a configuration name (e.g., square array), a pitch (e.g., isolation), a style (e.g., two edge scattering bar with a corner assist feature), a proximity, and specifications of the geometry (e.g., space, width, length, azimuth, angle) for each of the simplified rings (‘Ring 1’ and ‘Ring 2’) surrounding the center square and for the oblique scattering bars used as corner assist features. In some examples, the MBRT 906 may also provide a specification for the center square.

While the above discussion has been provided with reference to a square pattern (e.g., the square IC pattern 500), the various embodiments and methods described herein are not meant to be limited to such simple patterns or features. Rather, embodiments of the present disclosure (including the method 400) may be applied to any layout pattern, any arbitrary feature, and/or critical layout hotspot (as described above) to provide automated generation (e.g., by the mask data preparation 132) of a rule table for SRAF feature insertion. For example, FIG. 10A illustrates a layout 1002 including a critical pattern (i.e., layout hotspot) represented by a freeform irregular shape which may benefit from aspects of the disclosure provided herein. In some embodiments, the freeform irregular shape may be formed by an inverse lithography technology (ILT) process. Furthermore, in an embodiment of block 406 of the method 400, a simplification process may be performed (e.g., by the mask data preparation 132) to derive a simplified, manufacturing-friendly pattern approximating the freeform irregular shape of the layout 1002. In the example of FIG. 10A, the simplified pattern is represented by a plurality of rectangles (Rectangle 1, Rectangle 2, Rectangle 3, and Rectangle 4). However, as discussed above, the simplified pattern may include any of a variety of geometric shapes, where a determination of which shape(s) to implement in place of the freeform irregular shape of the layout 1002 is based on various factors such as manufacturing constraints (e.g., of the IC manufacturer's process), the process simulation for fabrication of the simplified pattern, computational capabilities, as well as design and performance constrains of a subsequently fabricated IC device.

As shown in FIG. 10A, the simplified pattern of the freeform irregular shape, as represented by the plurality of rectangles, may include rule configurations for each of the geometric shapes (e.g., the rectangles) used to form the simplified pattern. For example, a center point for each of the Rectangles 1, 2, 3, 4 may be determined relative to a vertex (e.g., an upper-left vertex) of the minimum box enclosing all main features (e.g., including the freeform irregular shape as well as features 1004, 1006, 1008). In the example of FIG. 10A, the plurality of features 1004, 1006, 1008 may include via or contact features; however, in other embodiments, other neighboring features may be present as well. Likewise, in other embodiments, other vertices of the minimum box enclosing all the main features, or vertices of a neighboring feature (such as features 1004, 1006, 1008) may instead be used as a reference point from which to measure a center point for each of the Rectangles 1, 2, 3, 4. In addition, a width, length, and angle (e.g., with respect to, for example, a horizontal reference plane) may be determined for each of the Rectangles 1, 2, 3, 4. In some examples, given the simplified pattern (e.g., as represented by the plurality of rectangles) and in an embodiment of block 408 of the method 400, SRAF rules may be determined (e.g., by the mask data preparation 132) and the SRAF rule table is updated. In particular, SRAF rules may be extracted and/or calculated based on the theoretical model and the simplified pattern of rectangles. As shown in FIG. 10B, an MBRT 1010 is determined. In various examples, the MBRT 1010 may include information such as a configuration name (e.g., random critical pattern), a pitch (e.g., non-periodic), a style (e.g., three close vias), a coordinate (e.g., relative to the upper-left vertex of the minimum box enclosing all main features—which also may correspond to a corner of the feature 1004), and specifications of the geometry (e.g., center, width, length, angle) for each of the rectangles (‘Rectangle 1’, ‘Rectangle 2’, ‘Rectangle 3’, and ‘Rectangle 4’).

In the above discussion, squares and rectangles are presented as manufacturing-friendly shapes. However, it is noted that in some embodiments other shapes, such as an ellipse, can also be used. In some examples, a mixture of more than one type of fabrication-friendly shape may be used. For example, in some embodiments, a freeform layout pattern (e.g., the freeform layout pattern 502) may be approximated by a combination of squares, rectangles, and/or ellipses.

In addition, the various embodiments disclosed herein, including the method 400, may be implemented on any suitable computing system, such as the mask design system 180 described in association with FIG. 3. In some embodiments, the method 400 may be executed on a single computer, local area networks, client-server networks, wide area networks, internets, hand-held and other portable and wireless devices and networks. Such a system architecture may take the form of an entirely hardware embodiment, an entirely software embodiment, or an embodiment containing both hardware and software elements. By way of example, hardware generally includes at least processor-capable platforms, such as client-machines (also known as personal computers or servers), and hand-held processing devices (such as smart phones, personal digital assistants (PDAs), or personal computing devices (PCDs), for example. In addition, hardware may include any physical device that is capable of storing machine-readable instructions, such as memory or other data storage devices. Other forms of hardware include hardware sub-systems, including transfer devices such as modems, modem cards, ports, and port cards, for example. In various examples, software generally includes any machine code stored in any memory medium, such as RAM or ROM, and machine code stored on other devices (such as floppy disks, flash memory, or a CD-ROM, for example). In some embodiments, software may include source or object code, for example. In addition, software may encompass any set of instructions capable of being executed in a client machine or server.

Furthermore, embodiments of the present disclosure can take the form of a computer program product accessible from a tangible computer-usable or computer-readable medium providing program code for use by or in connection with a computer or any instruction execution system. For the purposes of this description, a tangible computer-usable or computer-readable medium may be any apparatus that can contain, store, communicate, propagate, or transport the program for use by or in connection with the instruction execution system, apparatus, or device. The medium may be an electronic, magnetic, optical, electromagnetic, infrared, a semiconductor system (or apparatus or device), or a propagation medium.

In some embodiments, defined organizations of data known as data structures may be provided to enable one or more embodiments of the present disclosure. For example, a data structure may provide an organization of data, or an organization of executable code. In some examples, data signals may be carried across one or more transmission media and store and transport various data structures, and may thus be used to transport an embodiment of the present disclosure.

The embodiments of the present disclosure offer advantages over existing art, though it is understood that other embodiments may offer different advantages, not all advantages are necessarily discussed herein, and that no particular advantage is required for all embodiments. By the disclosed model-based rule table generation method, shortcomings of empirically generated rule table-based SRAF insertions are effectively overcome. For example, embodiments of the present disclosure provide for the generation of a process-aware rule table for SRAF insertions, wherein such an SRAF rule table that is generated, at least in part, by utilizing a process simulation for a given layout feature(s) (e.g., such as a layout hotspot). In contrast to conventional methods which require lithographic processing and empirical data collection, embodiments disclosed herein provide for the automated generation of a rule table for SRAF insertions based on a simulated process for adaptive, rapid rule table creation without costly development cycle delays. Those of skill in the art will readily appreciate that the methods described herein may be applied to a variety of other semiconductor layouts, semiconductor devices, and semiconductor processes to advantageously achieve similar benefits to those described herein without departing from the scope of the present disclosure.

Thus, one of the embodiments of the present disclosure described a method for fabricating a semiconductor device including receiving an integrated circuit (IC) layout pattern, for example, from a design house. In some embodiments, a process simulation model is utilized to generate a second layout pattern by an inverse lithography technology (ILT) process. The process simulation model is configured to simulate processing conditions for the IC layout pattern. In various embodiments, the second layout pattern is associated with the IC layout pattern. In some examples, a third layout pattern is generated (e.g., by the data preparation 132), where the third layout pattern is an approximation of the second layout pattern. Thereafter, sub-resolution assist feature (SRAF) rules, based on the third layout pattern, may be calculated (e.g., by the data preparation 132).

In another of the embodiments, discussed is a method for fabricating a semiconductor device including performing an ILT process to generate a freeform layout pattern. In some embodiments, utilizing a process simulation model and based on a plurality of manufacturing constraints, a simplified layout pattern is determined. By way of example, the simplified layout pattern corresponds to the freeform layout pattern. A plurality of rules may be extracted from the simplified layout pattern, and a rule table is generated based on the extracted plurality of rules.

In yet other embodiments, discussed is a method including receiving an IC design layout and identifying, by a mask design system, at least one layout hotspot in the received IC design layout. In various embodiments, the mask design system may provide an ILT-generated layout pattern that corresponds to the identified at least one layout hotspot. In some examples, the mask design system may then perform a layout simplification process to generate a simplified layout pattern corresponding to the ILT-generated layout pattern. In some embodiments, the mask design system may further calculate sub-resolution assist feature (SRAF) rules based on the generated simplified layout pattern.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of semiconductor device fabrication, comprising:
receiving an integrated circuit (IC) layout pattern;
utilizing a process simulation model configured to simulate processing conditions for the IC layout pattern, generating a second layout pattern by a model-based (MB) mask correction process, wherein the second layout pattern is associated with the IC layout pattern;
generating a third layout pattern that is an approximation of the second layout pattern; and
calculating sub-resolution assist feature (SRAF) rules based on the third layout pattern.

2. The method of claim 1, wherein the generating the second layout pattern by the MB mask correction process includes generating the second layout pattern by an inverse lithography technology (ILT) process.

3. The method of claim 1, wherein the calculating the SRAF rules further includes calculating the SRAF rules based on the process simulation model.

4. The method of claim 1, wherein the second layout pattern includes a freeform layout pattern, and wherein the third layout pattern includes a simplified pattern.

5. The method of claim 1, wherein the third layout pattern includes a plurality of user-defined shapes, and wherein the plurality of user-defined shapes include one or more selected from a square, a rectangle, and an ellipse.

6. The method of claim 1, wherein the generating the third layout pattern includes performing a pattern simplification process to generate the third layout pattern.

7. The method of claim 1, further comprising updating an SRAF rule table.

8. The method of claim 7, wherein the SRAF rule table includes a model-based rule table (MBRT), and wherein the MBRT includes rule configurations for the third layout pattern.

9. The method of claim 8, wherein the SRAF rule table is a hybrid rule table, and wherein the hybrid rule table includes a rule-based rule table and the model-based rule table (MBRT).

10. The method of claim 1, further comprising:
identifying a layout hotspot within the received IC layout pattern; and
utilizing the process simulation model configured to simulate processing conditions for the identified layout hotspot, generating the second layout pattern by the ILT process, wherein the second layout pattern is associated with the layout hotspot.

11. The method of claim 1, further comprising:
after calculating the SRAF rules, transmitting a modified IC layout pattern to a mask fabricator, wherein the modified IC layout pattern includes modifications corresponding to the calculated SRAF rules, and fabricating a mask based on the modified IC layout pattern.

12. A method of semiconductor device fabrication, comprising:
performing an inverse lithography technology (ILT) process to generate a freeform layout pattern;
utilizing a process simulation model, and based on a plurality of manufacturing constraints, determining a simplified layout pattern corresponding to the freeform layout pattern;
extracting a plurality of rules from the simplified layout pattern; and
generating a rule table based on the extracted plurality of rules.

13. The method of claim 12, wherein the freeform layout pattern corresponds to a layout hotspot.

14. The method of claim 12, wherein the rule table includes a sub-resolution assist feature (SRAF) rule table, and wherein the SRAF rule table provides rule configurations for a plurality of user-define shapes.

15. The method of claim 12, wherein the performing the ILT process to generate the freeform layout pattern includes utilizing the process simulation model to generate a particular freeform layout pattern that conforms to a plurality of process constraints defined by the process simulation model.

16. The method of claim 12, wherein the performing the ILT process, the determining the simplified layout pattern, the extracting the plurality of rules, and the generating the rule table are performed by a mask design system executing software instructions within a processor of the mask design system.

17. The method of claim 12, further comprising:
fabricating a mask including a mask pattern based on the generated rule table; and
transferring the mask pattern to a semiconductor wafer to fabricate an integrated circuit (IC) device on the semiconductor wafer.

18. A method, comprising:
receiving an integrated circuit (IC) design layout;
identifying, by a mask design system, at least one layout hotspot in the received IC design layout;
generating, by the mask design system, an inverse lithography technology (ILT)-generated layout pattern corresponding to the identified at least one layout hotspot;
performing, by the mask design system, a layout simplification process to generate a simplified layout pattern corresponding to the ILT-generated layout pattern;
and
calculating, by the mask design system, sub-resolution assist feature (SRAF) rules based on the generated simplified layout pattern.

19. The method of claim 18, further comprising generating an SRAF rule table based on the calculated SRAF rules.

20. The method of claim 18, further comprising:
identifying, by the mask design system, another layout hotspot in the received IC design layout, wherein the another layout hotspot includes the same pattern as the at least one layout hotspot; and
applying, to the another layout hotspot, the same generated simplified layout pattern and calculated SRAF rules used for the at least one layout hotspot, wherein the applying includes inserting, to the another layout hotspot, an SRAF based on the calculated SRAF rules.
